(19) United States
(12) Patent Application Publication
(10) Pub. No.: US 2017/0183543 A1
(43) Pub. Date: Jun. 29, 2017

(54) ANCHOR LAYER FORMATION COMPOSITION, ANCHOR LAYER, OPTICAL FILM PROVIDED WITH ADHESIVE LAYER, AND IMAGE DISPLAY DEVICE

(71) Applicant: NITTO DENKO CORPORATION, Ibaraki-shi, Osaka (JP)

(72) Inventors: Mizuho Nagata, Ibaraki-shi (JP); Toshitaka Takahashi, Ibaraki-shi (JP); Eriko Nakao, Ibaraki-shi (JP)

(73) Assignee: NITTO DENKO CORPORATION, Ibaraki-shi, Osaka (JP)

(21) Appl. No.: 15/315,489

(22) PCT Filed: Jun. 24, 2015
(86) PCT No.: PCT/JP2015/068249

§ 371 Date: Dec. 1, 2016

(30) Foreign Application Priority Data
Jul. 8, 2014 (JP) 2014-140710

(51) Int. Cl. C09J 7/02; B05D 1/18; B05D 1/30; B05D 1/28; B05D 1/02

(52) U.S. Cl. CPC C09J 7/0282; B05D 1/28; B05D 1/02; B05D 1/305; B05D 1/18; C09J 7/0246; C09J 2201/606; C09J 2433/00; C09J 133/14

(57) ABSTRACT

An anchor layer formation composition, a pressure-sensitive adhesive layer-attached optical film, and an image display device are provided, in which the composition includes an oxazoline group-containing polymer and an ionic compound including a cation component and a sulfonyl group-containing anion component and is capable of forming an anchor layer that can improve the adhesion between a pressure-sensitive adhesive layer and an optical film when interposed therebetween, the pressure-sensitive adhesive layer-attached optical film has high durability and good reworkability and allows the pressure-sensitive adhesive layer to resist chipping, and the image display device has the pressure-sensitive adhesive layer-attached optical film.

### TECHNICAL FIELD

The invention relates to an anchor layer formation composition, an anchor layer, a pressure-sensitive adhesive layer-attached optical film, and an image display device.

Liquid crystal display devices, organic EL display devices, etc. have an image-forming mechanism including polarizing elements as essential components. For example, therefore, in a liquid crystal display device, polarizing elements are essentially arranged on both sides of a liquid crystal cell, and generally, polarizing films are attached as the polarizing elements. Besides polarizing films, various optical elements for improving display quality have become used in display panels such as liquid crystal panels and organic EL panels. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, anti-glare treatment films for preventing glare on image display devices, and anti-reflection films such as anti-reflective films and low-reflective films. These films are generically called optical films.

When such an optical film is bonded onto a display panel such as a liquid crystal cell and organic EL panel, or onto a front plate thereof, a pressure-sensitive adhesive is usually used. About bonding between an optical film, and a display panel such as a liquid crystal cell or organic EL panel, a front plate, or an optical film, usually, a pressure-sensitive adhesive is used to cause the individual members to be bonded to adhere closely onto each other to decrease light loss. In such cases, a pressure-sensitive adhesive layer-carrying optical film, in which a pressure-sensitive adhesive layer is beforehand provided on a single side surface of an optical film, is generally used since the pressure-sensitive adhesive layer-carrying optical film has an advantage that no drying step is required tor bonding and fixing the optical film, and the like.

Optical films can easily shrink or expand under heating or humidifying conditions. If an optical film has low adhesion to a pressure-sensitive adhesive, lifting or peeling can occur between the optical film and the pressure-sensitive adhesive layer. Particularly when used in in-vehicle applications such as car navigation systems, where liquid crystal panels are required to have higher durability, optical films are exposed to high shrinkage stress and can more easily lift or peel. Specifically, for example, even if there is no problem in a reliability test performed at about 80° C. for TVs or the like, a problem such as lifting or peeling can easily occur in another reliability test performed at about 95° C. for in-vehicle products such as car navigation systems. After a pressure-sensitive adhesive layer-attached optical film is bonded to a liquid crystal display, if necessary, the optical film is temporarily peeled off and then bonded again (subjected to reworking). In this process, if the adhesion between the optical film and the pressure-sensitive adhesive is low, the pressure-sensitive adhesive can remain on the surface of the liquid crystal display, so that the problem of a failure to efficiently perform reworking can occur. Another problem can also easily occur in which if the edge of the pressure-sensitive adhesive layer-attached optical film comes into contact with a worker or something adjacent to it in the process of cutting, feeding, or handling it, the pressure-sensitive adhesive layer can be chipped off of the edge portion, which can cause a display failure in the liquid crystal panel. To solve these problems, a technique for increasing adhesion between an optical film and a pressure-sensitive adhesive layer is performed, which includes applying an anchor layer to the optical film and then applying the pressure-sensitive adhesive thereto.

Known examples of such an anchor layer include an undercoat layer containing an organometallic compound such as an organozirconium compound and an oxazoline group-containing resin (see, for example, Patent Document 1) and a layer including a mixture of an oxazoline group-containing polymer and a compound having a plurality of carboxyl groups (see, for example, Patent Document 2).

### PRIOR ART DOCUMENTS

### Patent Documents

Patent Document 1: JP-A-2007-70611

Patent Document 2: JP-A-2007-188040

### SUMMARY OF THE INVENTION

### Problems to be Solved by the Invention

The anchor layer described in Patent Documents 1 and 2, including an oxazoline group-containing polymer, does not have sufficient performance because in some cases, such as when a pressure-sensitive adhesive layer has a relatively high elastic modulus, it can reduce the adhesion between the substrate (optical film) and the pressure-sensitive adhesive layer, can give insufficient durability or reworkability to a pressure-sensitive adhesive layer-attached optical film, or can cause a problem such as chipping of the pressure-sensitive adhesive layer.

It is therefore an object of the invention to provide an anchor layer formation composition capable of forming an anchor layer that can improve the adhesion between a pressure-sensitive adhesive layer and an optical film when interposed between the optical film and the pressure-sensitive adhesive layer. It is another object of the invention to provide a pressure-sensitive adhesive layer-attached optical film that has high durability and good reworkability and allows the pressure-sensitive adhesive layer to resist chipping, and to provide an image display device having such a pressure-sensitive adhesive layer-attached optical film.

### Means for Solving the Problems

As a result of intensive studies to solve the problems, the inventors have accomplished the invention based on findings that the objects can be achieved by means of the anchor layer formation composition described below.

Thus, the present invention relates to an anchor layer formation composition, comprising:

an oxazoline group-containing polymer; and

an ionic compound comprising a cation component and a sulfonyl group-containing anion component.

In the anchor layer formation composition, wherein the anion component, is preferably at least one anion component selected from the group consisting of an anion component represented by formula (1): (CₙF₂ₙ₊₁SO₂)N⁻(SO₂CₘF₂ₘ₊₁), wherein n and m are each independently an integer of 1 to 10, (SO₂F)₂N⁻, and CF₃SO₃⁻.

In the anchor layer formation composition, wherein the cation component is preferably a lithium cation.

In the anchor layer formation composition, wherein the ionic compound is preferably lithium bis(nonafluorobutanesulfonyl)imide and/or lithium bis(trifluoromethanesulfonyl)imide.

The present invention relates to an anchor layer comprising a product made from the anchor layer formation composition.

The present invention relates to a pressure-sensitive adhesive layer-attached optical film, comprising:

an optical film;

the anchor layer; and

a pressure-sensitive adhesive layer made from a pressure-sensitive adhesive composition, wherein

the anchor layer is interposed between the optical film and the pressure-sensitive adhesive layer.

In the pressure-sensitive adhesive layer-attached optical film, wherein the pressure-sensitive adhesive composition preferably comprises a (meth)acryl-based polymer obtained by polymerizing a monomer composition comprising a (meth)acrylic ester and a carboxyl group-containing monomer, and wherein the carboxyl group-containing monomer preferably makes up 0.05 to 20% by weight of all monomers used to form the (meth)acryl-based polymer.

The present, invention relates to an image display device comprising the pressure-sensitive adhesive layer-attached optical film.

### Effect of the Invention

The anchor layer formation composition of the invention includes an oxazoline group-containing polymer and an ionic compound including a cation component and a sulfonyl group-containing anion component. Therefore, when an anchor layer made from the composition is interposed between an optical film and a pressure-sensitive adhesive layer stacked on each other, the anchor layer can improve the adhesion between the optical film and the pressure-sensitive adhesive layer. In addition, the pressure-sensitive adhesive layer-attached optical film containing an anchor layer made from the anchor layer formation composition of the invention has high durability and good reworkability and allows the pressure-sensitive adhesive layer to resist chipping.

### Mode for Carrying Out the Invention

1. Anchor Layer Formation Composition

The anchor layer formation composition of the invention includes an oxazoline group-containing polymer and an ionic compound including a cation component, and a sulfonyl group-containing anion component.

The oxazoline group-containing polymer contains a main chain being of an acryl skeleton or a styrene skeleton and has an oxazoline group in a side chain of the main chain, preferably an oxazoline group-containing acrylic polymer having a main chain being of an acryl skeleton and having an oxazoline group in a side chain of the main chain.

Examples of the oxazoline group include 2-oxazoline group, 3-oxazoline group and 4-oxazoline group. Among these, 2-oxazoline group is preferable. The 2-oxazoline group is generally represented by the following general formula (2):

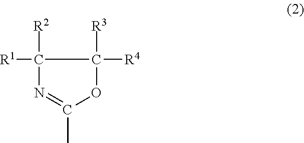

in the general formula (2), R¹ to R⁴ each independently represents a hydrogen atom, a halogen atom, an alkyl group, an aralkyl group, a phenyl group or a substituted phenyl group.

The oxazoline group-containing polymer may contain polyoxyalkylene-group in addition to the oxazoline group.

The number average molecular weight of the oxazoline group-containing polymer is preferably 5,000 or more, more preferably 10,000 or more, and usually 1,000,000 or less. When the number average molecular weight is lower than 5,000, cohesive failure may be caused because of poor strength of the anchor-layer, whereby an anchoring force may not be improved. When the number average molecular weight is higher than 1,000,000, workability may be inferior. The oxazoline value of the oxazoline group-containing polymer is preferable, for example, 1,500 g solid/eq. or less, more preferably 1,200 g solid/eq. or less. When the oxazoline value is larger than 1,500 g solid/eq., the amount of the oxazoline group in a molecule decreases, whereby the anchoring force may not be improved.

Since the oxazoline group of the oxazoline group-containing polymer reacts with a functional group, such as carboxyl group and hydroxyl group, contained in the pressure-sensitive adhesive composition at relatively low temperatures, the oxazoline group-containing polymer reacts with the functional group or the like in the pressure-sensitive adhesive layer and can firmly adhere to the pressure-sensitive adhesive layer when contained in the anchor-layer.

Examples of the oxazoline group-containing polymer include oxazoline group-containing acrylic polymers such as EPOCROS WS-300, EPOCROS WS-500, EPOCROS WS-700, manufactured by Nippon Shokubai Co., Ltd.; and oxazoline group-containing acryl/styrene polymers such as EPOCROS K-1000 series, EPOCROS K-2000 series, manufactured by Nippon Shokubai Co., Ltd. The oxazoline group-containing polymers may be used alone or in the form of a mixture of two or more thereof.

The content of the oxazoline group-containing polymer in the anchor layer formation composition is preferably from. 0.005 to 5% by weight, more preferably from 0.01 to 3% by weight, even more preferably from 0.01 to 1% by weight, most preferably from 0.01 to 0.5% by weight. When the content of the oxazoline group-containing polymer is in these ranges, the anchor layer can have a higher level, of adhesion to the pressure-sensitive adhesive layer made from the pressure-sensitive adhesive composition and can also surely have a certain level of strength, which is preferred.

The content of the oxazoline group-containing polymer in an anchor layer comprising a product made from the anchor layer formation composition is preferably 10% by weight or more, more preferably 20% by weight or more, when the content of the oxazoline group-containing polymer is in these ranges, the anchor layer can have improved adhesion to the pressure-sensitive adhesive layer made from the water-dispersible pressure-sensitive adhesive composition, which is preferred.

The anchor layer formation composition of the invention has the feature that it contains, together with the oxazoline group-containing polymer, an ionic compound including a cation component and a sulfonyl group-containing anion component. The pressure-sensitive adhesive layer-attached optical film including an optical film, a pressure-sensitive adhesive layer, and an anchor layer made from the composition and interposed between the optical film and the pressure-sensitive adhesive layer has high adhesion between the pressure-sensitive adhesive layer and the optical film, allows the pressure-sensitive adhesive layer to have high durability and good reworkability, and also allows the pressure-sensitive adhesive layer to resist chipping.

The anion component of the ionic compound has a sulfonyl group. More specifically, in view of adhesion, the ionic compound preferably has at least one anion component selected from the group consisting of an anion component represented by formula (1): (CₙF₂ₙ₊₁SO₂)N⁻(SO₂CₘF₂ₘ₊₁), wherein n and m are each independently an integer of 1 to 10, (SO₂F)₂N⁻, and CF₃SO₃⁻.

Specifically, the anion component represented by formula (1) may be, for example, a bis (trifluoromethanesulfonyl)imide anion, a bis(pentafluoroethanesulfonyl)imide anion, a bis(heptafluoropropanesulfonyl)imide anion, a bis(nonafluorobutanesulfonyl)imide anion, a bis(undecafluoropentanesulfonyl)imide anion, a bis(tridecafluorohexanesulfonyl)imide anion, a bis(pentadecafluoroheptanesulfonyl)imide anion, a trifluoromethanesulfonylnonafluorobutanesulfonylimide anion, a heptafluoropropanesulfonyltrifluoromethanesulfonylimide anion, or a pentafluoroethanesulfonylnonafluorobutanesulfonylimide anion. Among them, a bis(trifluoromethanesulfonyl)imide anion and a bis(nonafluorobutanesulfonyl)imide anion are preferred.

The ionic compound may also have a ring structure-containing anion component, for example, represented by formula (3): CF₂(CₚF₂ₚSO₂)₂N⁻, wherein p is an integer of 1 to 10.

Specifically, the anion component represented by formula (3) may be a hexafluoropropane-1,3-disulfonimide anion.

Besides the anion component represented by formula (1), the anion component of the ionic compound is preferably, for example, (SO₂F)₂N⁻ or CF₃SO₃⁻.

The cation component may be an alkali metal ion such as a lithium, sodium, or potassium ion. The alkali metal ion and the anion component form an alkali metal salt as the ionic compound. In particular, the ionic compound preferably has a lithium ion among alkali metal ions because the lithium ion-containing ionic compound has the catalytic activity to facilitate the reaction between an oxazoline group and a carbonyl group in a pressure-sensitive adhesive.

The cation component may also be an organic cation. The organic cation and the anion component form an organic cation-anion salt as the ionic compound. Specifically, the organic cation may be, for example, a pyridinium cation, a piperidinium cation, a pyrrolidinium cation, a pyrroline skeleton-containing cation, a pyrrole skeleton-containing cation, an imidazolium cation, a tetrahydropyrimidinium cation, a dihydropyrimidinium cation, a pyrazolium cation, a pyrazolinium cation, a tetraalkylammonium cation, a trialkylsulfonium cation, or a tetraalkylphosphonium cation.

Specific examples of the ionic compound include lithium bis(trifluoromethanesulfonyl)imide, lithium bis(pentafluoroethanesulfonyl)imide, lithium bis(heptafluoropropanesulfonyl)imide, lithium bis(nonafluorobutanesulfonyl)imide, lithium bis(undecafluoropentanesulfonyl)imide, lithium bis(tridecafluorohexanesulfonyl)imide, lithium bis(pentadecafluoroheptanesulfonyl)imide, lithium trifluoromethanesulfonylnonafluorobutanesulfonylimide, lithium heptafluoropropanesulfonyltrifluoromethanesulfonylimide, lithium pentafluoroethanesulfonylnonafluorobutanesulfonylimide, lithium hexafluoropropane-1,3-disulfonimide, sodium bis(trifluoromethanesulfonyl)imide, sodium bis(pentafluoroethanesulfonyl)imide, sodium bis(heptafluoropropanesulfonyl)imide, sodium bis(nonafluorobutanesulfonyl)imide, sodium bis(undecafluoropentanesulfonyl)imide, sodium bis(tridecafluorohexanesulfonyl)imide, sodium bis(pentadecafluoroheptanesulfonyl)imide, sodium trifluoromethanesulfonylnonafluorobutanesulfonylimide, sodium heptafluoropropanesulfonyltrifluoromethanesulfonylimide, sodium pentafluoroethanesulfonylnonafluorobutanesulfonylimide, sodium hexafluoropropane-1,3-disulfonimide, potassium bis(trifluoromethanesulfonyl)imide, potassium bis(pentafluoroethanesulfonyl)imide, potassium bis(heptafluoropropanesulfonyl)imide, potassium bis(nonafluorobutanesulfonyl)imide, potassium bis(undecafluoropentanesulfonyl)imide, potassium bis(tridecafluorohexanesulfonyl)imide, potassium bis(pentadecafluoroheptanesulfonyl)imide, potassium trifluoromethanesulfonylnonafluorobutanesulfonylimide, potassium heptafluoropropanesulfonyltrifluoromethanesulfonylimide, potassium pentafluoroethanesulfonylnonafluorobutanesulfonylimide, and potassium hexafluoropropane-1,3-disulfonimide. These may be used singly or in combination of two or more. Among them, lithium bis(trifluoromethanesulfonyl)imide and lithium, bis(nonafluorobutanesulfonyl)imide are preferred.

Examples of the ionic compound include EF-N445 (lithium bis(nonafluorobutanesulfonyl)imide) and EF-N115 (lithium bis(trifluoromethanesulfonyl)imide) manufactured by Mitsubishi Materials Electronic Chemicals Co., Ltd., Li(SO₂F)₂N manufactured by NIPPON SHOKUBAI CO., LTD., and LiCF₃SO₃ manufactured by MORITA CHEMICAL INDUSTRIES CO., LTD. These compounds may be used singly or in combination of two or more.

The content of the ionic compound in the anchor layer formation composition is preferably from. 0.001 to 5% by weight, more preferably from 0.005 to 3% by weight, even more preferably from 0.01 to 2% by weight. When the content of the ionic compound is in these ranges, the adhesion between the optical film and the pressure-sensitive adhesive layer made from, the pressure-sensitive adhesive composition can be advantageously improved.

The content of the ionic compound is preferably from 1 to 500 parts by weight, more preferably from 1 to 200 parts by weight, based on 100 parts by weight of the oxazoline group-containing polymer. When the content of the ionic compound is in these ranges, the anchor layer can advantageously have improved adhesion, to the pressure-sensitive adhesive layer made from the pressure-sensitive adhesive composition.

The anchor layer formation composition may contain a solvent, which, is preferably, but not limited to, an aqueous solvent. The aqueous solvent to be used includes 60% by weight or more of water. The water content is preferably 70% by weight or more, more preferably 90% by weight or more, even more preferably 95% by weight or more, further more preferably 97% by weight or more, still more preferably 99% by weight or more, yet more preferably 100% by weight (water alone). For example, a mixed solvent including 60 to 100% by weight of water and 0 to 40% by weight of an alcohol may be used. In this case, the alcohol content of the solvent composition is preferably 40% by weight or less, more preferably 30% by weight or less, even more preferably 10% by weight or less, further more preferably 5% by weight or less, still more preferably 3% by weight or less, yet more preferably 1% by weight or less. In particular, no use of any alcohol is preferred. Most of the aqueous solvent is removed in the step of drying the anchor layer being formed. However, if the alcohol content, of the aqueous solvent is over the range, a plasticizer and other components may leach out of the surface of the optical film in contact with the anchor layer, leading to a reduction in the compatibility between the optical film and the pressure-sensitive adhesive layer made from the pressure-sensitive adhesive composition.

Preferably, the alcohol is hydrophilic at room temperature (25° C.) and miscible particularly with water in any proportion. The alcohol with such features is preferably an alcohol of 1 to 6 carbon atoms, more preferably an alcohol of 1 to 4 carbon atoms, even more preferably an alcohol of 1 to 3 carbon atoms. Examples of the alcohol with such features include methanol, ethanol, n-propanol, isopropyl alcohol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol. These may be used alone or in a mixture of two or more.

In view of the conducting performance and optical properties of the anchor layer, the anchor layer formation composition of the invention may contain a polythiophene polymer in addition to the oxazoline group-containing polymer, the ionic compound, and the aqueous solvent.

Various forms of the polythiophene based polymer may be used. A water-soluble or water dispersible polymer can be suitably used.

The word “water-soluble” or “water-solubility” denotes that the solubility of any compound in 100 g of water is 5 g or more. The solubility of the water-soluble polythiophene based polymer in 100 g of water is preferably from 20 to 30 g. The polythiophene based polymer that is water-dispersible is a polymer that is dispersible in water in the state that the polymer is in the form of fine particles. A water-dispersible liquid is small in liquid viscosity to be easily used for thin film coating, and further the resultant painted layer is excellent in evenness. The size of the fine particles is preferably 1 μm or less from the viewpoint of the evenness of the anchor layer.

The water-soluble or water-dispersible polythiophene based polymer preferably has, in the molecule thereof, a hydrophilic functional group. Examples of the hydrophilic functional group include a sulfonic group, an amino group, an amide group, an imino group, a quaternary ammonium salt, a hydroxyl group, a mercapto group, a hydrazino group, a carboxyl group, a sulfate group, and a phosphate group; and salts of these groups. When the polymer has in the molecule a hydrophilic functional group, the polymer is easily soluble in water, or is easily dispersible, in the form of fine particles, in water. Thus, the water-soluble or water-dispersible polythiophene based polymer can easily be prepared.

The weight-average molecular weight of the polythiophene based polymer is preferably 400000 or less, more preferably 300000 or less in terms of that of polystyrene. If the weight-average molecular weight is more than the upper value, the polymer tends not to satisfy the water-solubility or water-dispersibility. When such a polymer is used to prepare a composition, a solid of the polymer tends to remain in the composition, or the polymer tends to be increased in viscosity so that an anchor layer with even film thickness is hard to be formed.

Examples of the water-soluble or water-dispersible polythiophene based polymer include DENATRON series polymers manufactured by Nagase ChemteX Corp (for example, DENATRON P-580W).

The content of the polythiophene based polymer in the anchor layer formation composition is preferably from 0.005 to 5% by weight, more preferably from 0.01 to 3% by weight, even more preferably from 0.01 to 1% by weight, further more preferably 0.01 to 0.5% by weight.

The content of the polythiophene polymer is preferably from 80 to 300 parts by weight, more preferably from 90 to 200 parts by weight, based on 100 parts by weight of the oxazoline group-containing polymer.

In addition to the components described above, the anchor layer formation composition for use in the invention may also contain a binder component for improving the anchoring properties or the tackiness between the optical film and the pressure-sensitive adhesive layer.

For improving the anchoring strength of the pressure-sensitive adhesive, any resin (polymer) having an organic reactive group such as a polyurethane resin based binder such as a water-soluble or water-dispersible polyurethane resin based binder, an epoxy resin based binder, an isocyanate resin based binder, and a polyester resin based binder.

The content of the binder resin in the anchor layer formation composition is preferably 5% by weight or less, more preferably from 0.005 to 5% by weight.

An additive may be blended into the anchor layer formation composition if necessary. Examples of the additive include a leveling agent, an antifoaming agent, a thickener, and an antioxidant. Of these additives, preferred is a leveling agent (for example, one having an acetylene skeleton).

The solid concentration of anchor layer formation, composition is preferably 0.01 to 10% by weight, more preferably 0.01 to 3% by weight, even more preferably 0.1 to 3% by weight.

2. Anchor Layer

The anchor layer of the invention includes a product made from the anchor layer formation composition. Methods for forming the anchor layer will be described later.

3. Pressure-Sensitive Adhesive Layer-Attached Optical Film

The pressure-sensitive adhesive layer-attached optical film of the invention includes an optical film, the anchor layer, and a pressure-sensitive adhesive layer made from a pressure-sensitive adhesive composition, in which the anchor layer is interposed between the optical film and the pressure-sensitive adhesive layer.

(1) Optical Film

The optical film used to form the pressure-sensitive adhesive layer-attached optical film of the invention may be of any type used in image display devices such as liquid crystal display devices. The optical film may be, for example, a polarizing film. A polarizing film including a polarizer and a transparent protective film or films provided on one or both sides of the polarizer may be generally used.

The polarizer is not particularly limited, and those of various types may be used. Examples of the polarizer include a polarizer obtained by adsorbing a dichroic substance such as an iodine or a dichroic dye into a hydrophilic polymer film, such as a polyvinyl alcohol film, a partially formalated polyvinyl alcohol film or an ethylene/vinyl acetate copolymer partially saponified film, and then drawing the film monoaxially, or a polyene-oriented film, made of, for example, a polyvinyl-alcohol dehydrated product or a polyvinyl-chloride dehydrochloride-treated product. Of such films, preferred is a polarizer composed of a polyvinyl alcohol film and a dichroic substance such as an iodine. The thickness of such a polarizer is not particularly limited, and in general, is approximately from 5 to 80 μm.

The polarizer obtained by dyeing a polyvinyl alcohol film with an iodine and then, drawing the film monoaxially may be formed, for example, by immersing (a) polyvinyl alcohol (film) in an aqueous solution of iodine so as to be dyed, and then drawing the film into a length 3 to 7 times the original length. If necessary, the film may be immersed in an aqueous solution of potassium iodide or the like that may contain, for example, boric acid, zinc sulfate, or zinc chloride. Before dyeing, the polyvinyl alcohol film may be immersed in water to be washed as needed. Washing of the polyvinyl alcohol film with water makes it possible to clean off stains or a blocking inhibitor on surfaces of the polyvinyl alcohol film, and further causes the polyvinyl alcohol film to be swelled, thus producing an advantageous effect of preventing an unevenness in the dyed color or the like. The drawing may be performed after, while or before dyeing with iodine is performed. The drawing may be performed in an aqueous solution of boric acid, potassium iodide or the like, or in a water bath.

As the material constituting the transparent protective film, for example, a thermoplastic resin excellent in transparency, mechanical strength, thermal stability, water blocking performance, isotropy, and others are used. Specific examples of the thermoplastic resin include cellulose resins such as triacetylcellulose, polyester resin, polyethersulfone resin, polysulfone resin, polycarbonate resin, polyamide resin, polyimide resin, polyolefin resin, (meth)acrylate resin, cyclic polyolefin resin (norbornene based resin), polyarylate resin, polystyrene resin and polyvinyl alcohol resin; and mixtures thereof. The transparent protective film is bonded to one surface of the polarizer through the adhesive layer, while a thermosetting resin or ultraviolet curable resin of, for example, a (meth)acrylic, urethane, acrylic urethane, epoxy or silicone type may be used on the other surface as a transparent protective film. The transparent protective film may contain any one or more appropriate additives.

Examples of the additives include an ultraviolet absorbent, an antioxidant, a lubricant, a plasticizer, a release agent, a coloring inhibitor, a flame retardation, a nucleating agent, an antistatic agent, a pigment, and a colorant.

The content of the thermoplastic resin in the transparent protective film is preferably from 50 to 100% by weight, more preferably from 50 to 99% by weight, even more preferably from 60 to 98% by weight, in particular preferably from 70 to 97% by weight. If the content of the thermoplastic resin in the transparent protective film is less than 50% by weight, it is feared that a high transparency which a thermoplastic resin originally has cannot be sufficiently exhibited.

The optical film may be an optical layer that may be used to form, for example, a liquid crystal display device. Examples thereof include reflectors, anti-transmission plates, retardation plates, which may be, for example, 1/2 and 1/4 wavelength plates, viewing angle compensation films, brightness enhancement films, and surface treatment films. These may be used alone as an optical film, or may be used in a form that two or more thereof are laminated onto the polarizing plate when practically used.

A surface treatment film may be provided by being bonded onto a front plate. Examples of the surface treatment film include a hard coat film for giving scratch resistance to a surface, an antiglare treatment film to prevent casting a glare on an image display device, and reflection reduction films such as an antireflective film and a low reflective film. The front plate is provided by being bonded onto the front surface of an image display device, such as a liquid crystal display device, an organic EL display device, a CRT or a PDP, to protect the image display device, give a high-class impression thereto, and discriminate the device from others by a design thereof. The front plate may be used as a supporter for a λ/4 plate in a 3D-TV. For example, in a liquid crystal display device, a front plate is located over its polarizing plate at the viewer-side of the device.

The optical film in which two or more of the above-mentioned optical layers are laminated on a polarizing plate may be formed by a method of laminating the optical layers successively and individually in a process for producing, for example, a liquid crystal display device. The optical film obtained by laminating the optical layers beforehand is excellent in quality stability, fabricating workability and the like to produce an advantage of being able to enhance the process for producing a liquid crystal display device and the like. For the laminating, any appropriate adhesive means, such as a pressure-sensitive adhesive layer, may be used. When the polarizing film is adhered to other optical layers, an optical axis of these members may be set to an appropriate layout angle in accordance with, for example, a target retardance property.

(2) Pressure-Sensitive Adhesive Layer

In the invention, the pressure-sensitive adhesive composition used to form the pressure-sensitive adhesive layer may be, for example, an acrylic pressure-sensitive adhesive, a synthetic rubber-based pressure-sensitive adhesive, a rubber-based pressure-sensitive adhesive, or a silicone-based pressure-sensitive adhesive. In view of transparency, heat resistance, and other properties, the pressure-sensitive adhesive composition is preferably an acrylic pressure-sensitive adhesive including a (meth)acryl-based polymer as a base polymer.

The (meth)acryl-based polymer as a base polymer in the acrylic pressure-sensitive adhesive is preferably a product obtained by polymerizing a monomer composition including a (meth)acrylic ester and a carboxyl group-containing monomer. In this regard, the term “(meth)acrylic ester” refers to “acrylic ester and/or methacrylic ester,” and “(meth)” has the same meaning with respect to the invention.

Examples of the (meth)acrylic ester include methyl (meth)acrylate, ethyl (meth)acrylate, n-butyl (meth)acrylate, tert-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, and n-tetradecyl (meth)acrylate. These may be used singly or in combination of two or more. Among them, a (meth)acrylic ester having an alkyl group of 2 to 14 carbon atoms is preferred, and a (meth)acrylic ester having an alkyl group of 2 to 12 carbon atoms is more preferred.

The content of the (meth)acrylic ester in all the monomers used to form the (meth)acryl-based polymer is preferably 60% by weight or more, more preferably 70% by weight or more, even more preferably 80% by weight or more, further more preferably 90% by weight or more.

Any monomer having a carboxyl group and an unsaturated double bond-containing polymerizable functional group such as a (meth)acryloyl group or a vinyl group may be used without restriction as the carboxyl group-containing monomer. Examples of the carboxyl group-containing monomer include acrylic acid, methacrylic acid, carboxyethyl (meth)acrylate, carboxypentyl (meth)acrylate, itaconic acid, maleic acid, fumaric acid, and crotonic acid. These may be used alone or in any combination.

The content of the carboxyl group-containing monomer in all the monomers used to form the (meth)acryl-based polymer is preferably from 0.05 to 20% by weight, more preferably from 0.05 to 10% by weight, even more preferably from 0.5 to 10% by weight. When the content of the carboxyl group-containing monomer is in these ranges, the pressure-sensitive adhesive composition can advantageously form a pressure-sensitive adhesive layer with improved adhesion to optical films and glass and can also advantageously form a mechanically-stable emulsion pressure-sensitive adhesive (liquid).

The monomer composition may contain an additional polymerizable monomer other than the (meth)acrylic ester and the carboxyl group-containing monomer. The additional polymerizable monomer may be of any type having an unsaturated double bond-containing polymerizable functional group such as a (meth acryloyl group or a vinyl group. The additional polymerizable monomer may be, for example, a hydroxyl group-containing monomer or an alkoxysilyl group-containing monomer.

Any monomer having a hydroxyl group and an unsaturated double bond-containing polymerizable functional group such as a (meth)acryloyl group or a vinyl group may be used without restriction as the hydroxyl group-containing monomer. Examples of the hydroxyl group-containing monomer include 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)methyl (meth)acrylate. These may be used alone or in any combination.

The content of the hydroxyl group-containing monomer in all the monomers used to form the (meth)acryl-based polymer is preferably 10% by weight or less, more preferably 0 to 5% by weight, even more preferably from 0.01 to 4% by weight.

Examples of the alkoxysilyl group-containing monomer include an alkoxysilyl group-containing (meth)acrylate monomer and an alkoxysilyl group-containing vinyl monomer. Examples of the alkoxysilyl group-containing (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

The content of the alkoxysilyl group-containing monomer in all monomer components of the (meth)acryl-based polymer is preferably 5% by weight or less, more preferably from 0 to 3% by weight, and even, more preferably from 0.01 to 1% by weight.

The copolymerizable monomer may be a phosphate group-containing monomer. For example, the phosphate group-containing monomer may be a phosphate group-containing monomer represented by formula (4) below.

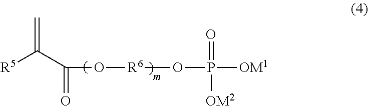

In formula (4), R⁵ represents a hydrogen atom or a methyl group, R⁶ represents an alkylene group of 1 to 4 carbon atoms, m represents an integer of 2 or more, and M¹ and M² each independently represent a hydrogen atom or a cation.

In formula (4), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may include random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

The content of the phosphate group-containing monomer in all the monomers used to form the (meth)acryl-based polymer is preferably 10% by weight or less, more preferably 5% by weight or less.

The additional copolymerizable monomer may be of any type having an unsaturated double bond-containing polymerizable functional group such as a (meth)acryloyl group or a vinyl group. Examples of the additional copolymerizable monomer include alicyclic hydrocarbon (meth)acrylates such as cyclohexyl (meth)acrylate, bornyl (meth)acrylate, and isobornyl (meth)acrylate; aryl (meth)acrylates such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; amide group-containing monomers such as acrylamide, diethylacrylamide, acryloylmorpholine (ACMO), and N-vinylpyrrolidone (NVP); amino group-containing monomers such as N,N-dimethylaminoethyl (meth)acrylate and N,N-dimethylaminopropyl (meth)acrylate; cyclic nitrogen-containing monomers such as N-vinylpyrrolidone, N-vinyl-ε-caprolactam, and methylvinylpyrrolidone; alkoxy group-containing monomers such, as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methyl itaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer may also be used as the copolymerizable monomer. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; and compounds having two or more reactive unsaturated double bonds, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

The content of the copolymerizable monomers other them the hydroxyl group-containing monomer, the carboxyl group-containing monomer, the alkoxysilyl group-containing monomer, and the phosphate group-containing monomer in the monomer composition is preferably 30% by weight or less, more preferably 0 to 20% by weight, even more preferably 0 to 10% by weight.

The (meth)acryl-based polymer used in the invention preferably has a weight average molecular weight in the range of 1,200,000 to 3,000,000, more preferably 1,200,000 to 2,700,000, even more preferably 1,200,000 to 2,500,000. A weight average molecular weight of less than 1,200,000 is not preferred in terms of heat resistance in some cases. Also, if the polymer has a weight average molecular weight of less than 1,200,000, the pressure-sensitive adhesive composition may have a high content of low-molecular-weight components, which may bleed out of the pressure-sensitive adhesive layer to degrade the transparency. Also, the pressure-sensitive adhesive layer obtained using the (meth)acryl-based polymer with a weight average molecular weight of less than 1,200,000 may have a low level of solvent resistance or mechanical properties. The polymer with an average molecular weight of more than 3,000,000 may require a large amount of a diluent solvent for controlling coating viscosity, which is not preferred in view of cost. The polymer with a weight average molecular weight in the above ranges is also preferred in view of corrosion resistance or durability. The weight average molecular weight refers to the polystyrene-equivalent value measured and calculated by gel permeation chromatography (GPC).

The (meth)acryl-based polymer described above can be produced, but are not limited to, by any method appropriately selected from known methods such as solution polymerization, bulk polymerization, emulsion polymerization, and various types of radial polymerization. The resulting (meth)acryl-based polymer may be a random copolymer, a block copolymer, a graft copolymer, or any other form. The (meth)acryl-based polymer may also be produced in the form of an aqueous dispersion, which contains the (meth)acryl-based polymer, or may also be produced in the form of an aqueous dispersion containing emulsion particles with a core-shell structure.

In a solution polymerization process, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Any appropriate polymerization initiator, chain transfer agent, emulsifying agent and so on may be selected and used for radical polymerization. The weight average molecular weight of the (meth)acryl-based polymer may be controlled by the reaction conditions including the amount of addition of the polymerization initiator or the chain transfer agent. The amount of the addition may be controlled as appropriate depending on the type of these materials.

Examples of the polymerization initiator include, but are not limited to, azo initiators such as 2,2′-azobisisobutyronitrile, 2,2′-azobis(2-amidinopropane) dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (trade name: VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, hydrogen peroxide, and benzoyl peroxide; and redox system initiators of a combination, of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The content of the polymerization initiator is preferably from about 0.005 to 1 part by weight, based on 100 parts by total weight of the monomer component used to form the (meth)acryl-based polymer.

Examples of the chain transfer agent include lauryl mercaptan, glycidyl mercaptan, mercaptoacetic acid, 2-mercaptoethanol, thioglycolic acid, 2-ethylhexyl thioglycolate and 2,3-dimercapto-1-propanol. One of these chain transfer agents may be used alone, or two or more thereof may be used in a mixture. The total content of the chain transfer agent is preferably about 0.1 parts by weight or less, based on 100 parts by total weight of the monomer component.

To improve adhesion under high-temperature, high-humidity conditions, any of various silane coupling agents may be added to the pressure-sensitive adhesive composition of the invention. Silane coupling agents having any appropriate functional group may be used. Examples of such a functional group include vinyl, epoxy, amino, mercapto, (meth)acryloxy, acetoacetyl, isocyanate, styryl, and polysulfide groups. Examples of the silane coupling agent include a vinyl group-containing silane coupling agent such as vinyltriethoxysilane, vinyltripropoxysilane, vinyltriisopropoxysilane, or vinyltributoxysilane; an epoxy group-containing silane coupling agent such as γ-glycidoxypropyltrimethoxysilane, γ-glycidoxypropyltriethoxysilane, 3-glycidoxypropylmethyldiethoxysilane, or 2-(3,4-epoxycyclohexyl)ethyltrimethoxysilane; an amino group-containing silane coupling agent such as γ-aminopropyltrimethoxysilane, N-β-(aminoethyl)-γ-aminopropylmethyldimethoxysilane, N-(2-aminoethyl)3-aminopropylmethyldimethoxysilane, γ-triethoxysilyl-N-(1,3-dimethylbutylidene)propylamine, or N-phenyl-γ-aminopropyltrimethoxysilane; a mercapto group-containing silane coupling agent such as γ-mercaptopropylmethyldimethoxysilane, a styryl group-containing silane coupling agent such as p-styryltrimethoxysilane; a (meth)acrylic group-containing silane coupling agent such as γ-acryloxypropyltrimethoxysilane or γ-methacryloxypropyltriethoxysilane; an isocyanate group-containing silane coupling agent such as 3-isocyanatepropyltriethoxysilane; and a polysulfide group-containing silane coupling agent such as bis(triethoxysilylpropyl)tetrasulfide.

The silane coupling agents may be used alone or in combination of two or more. Based on 100 parts by weight (on a solid basis) of the based polymer, the total content of the silane coupling agent(s) is preferably 1 part by weight or less, more preferably from 0.01 to 1 part by weight, even more preferably from 0.02 to 0.8 parts by weight, still more preferably from 0.05 to 0.7 parts by weight. If the content of the silane coupling agent is more than 1 part by weight, part of the coupling agent may remain unreacted, which is not preferred in view of durability.

When the silane coupling agent is radically copolymerizable with the above monomer component, it may be used as one of the monomer components. In such a case, the content of the silane coupling agent is preferably from 0.005 to 0.7 parts by weight based on 100 parts by weight of (on a solid basis) of the based polymer.

The pressure-sensitive adhesive composition of the invention may further contain a crosslinking agent. A polyfunctional compound may be used as a crosslinking agent, examples of which include an organic crosslinking agent and a polyfunctional metal chelate. Examples of the organic crosslinking agent include an epoxy crosslinking agent, an isocyanate crosslinking agent, a carbodiimide crosslinking agent, an imine crosslinking agent, an oxazoline crosslinking agent, an aziridine crosslinking agent and a peroxide crosslinking agent, etc. The polyfunctional metal chelate may comprise a polyvalent metal atom and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include an alkyl ester, an alcohol compound, a carboxylic acid compound, an ether compound, and a ketone compound. Among these crosslinking agents, the isocyanate crosslinking agent is preferred because it can provide a cohesive strength that will contribute to the durability of the pressure-sensitive adhesive, and more preferably, the isocyanate crosslinking agent is used in combination with the peroxide crosslinking agent. These crosslinking agents may be used singly or in combination of two or more. Among them, a peroxide crosslinking agent and an isocyanate crosslinking agent are preferred.

Examples of isocyanate crosslinking agent include a compound having two or more isocyanate groups (which may include functional groups that are temporarily protected with an isocyanate blocking agent or by oligomerization and are convertible to isocyanate groups) per molecule.

Isocyanate crosslinking agents include aromatic isocyanates such as tolylene diisocyanate and xylene diisocyanate, alicyclic isocyanates such as isophorone diisocyanate, and aliphatic isocyanates such as hexamethylene diisocyanate.

More specifically, examples of isocyanate crosslinking agents include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic diisocyanates such as 2,4-tolylene diisocyanate, 4,4′-diphenylmethane diisocyanate, xylylene diisocyanate, and polymethylene polyphenyl isocyanate; isocyanate adducts such as a trimethylolpropane-tolylene diisocyanate trimer adduct (trade name: CORONATE L, manufactured by NIPPON POLYURETHANE INDUSTRY CO., LTD.), a trimethylolpropane-hexamethylene diisocyanate trimer adduct (trade name: CORONATE HL, manufactured by NIPPON POLYURETHANE INDUSTRY CO., LTD.), and an isocyanurate of hexamethylene diisocyanate (trade name: CORONATE HX, manufactured by NIPPON POLYURETHANE INDUSTRY CO., LTD.); a trimethylolpropane adduct of xylylene diisocyanate (trade name: D110N, manufactured by Mitsui Chemicals, Inc.) and a trimethylolpropane adduct of hexamethylene diisocyanate (trade name: D160N, manufactured by Mitsui Chemicals, Inc.); polyether polyisocyanate and polyester polyisocyanate; adducts thereof with various polyols; and polyisocyanates polyfunctionalized with an isocyanurate bond, a biuret bond, an allophanate bond, or the like. Among them, the aliphatic isocyanate is preferably used because it can have a high reaction rate.

As the peroxide crosslinking agent, various kinds of peroxides are used. Examples of the peroxide include di-(2-ethylhexyl)peroxydicarbonate, di(4-t-butylcyclohexyl)peroxydicarbonate, di-sec-butyl peroxydicarbonate, t-butyl peroxyneodecanoate, t-hexyl peroxypivalate, t-butyl peroxypivalate, dilauroyl peroxide, di-n-octanoyl peroxide, 1,1,3,3-tetramethylbutyl peroxyisobutyrate, 1,1,3,3-tetramethylbutylperoxy-2-ethylhexanoate, di-(4-methylbenzoyl)peroxide, dibenzoyl peroxide and t-butyl peroxyisobutyrate. Among them, particularly, di(4-1-butylcyclohexyl)peroxydicarbonate, dilauroyl peroxide and dibenzoyl peroxide, which are excellent in crosslinking reaction efficiency, are preferably used.

As a non-limiting example, the pressure-sensitive adhesive composition may generally contain about 10 parts by weight or less (on a solid basis) of the crosslinking agent based on 100 parts by weight (on a solid basis) of the base polymer. The content of the crosslinking agent is preferably from about 0.01 to about 10 parts by weight, more preferably from about 0.01 to about 5 parts by weight, based on 100 parts by weigh of the base polymer. Particularly when a peroxide crosslinking agent is used, the pressure-sensitive adhesive composition preferably contains about 0.05 to about 1 part by weight, more preferably about 0.06 to about 0.5 parts by weight of the peroxide crosslinking agent, based on 100 parts by weight (on a solid basis) of the base polymer.

If necessary, the pressure-sensitive adhesive composition of the present invention may further appropriately contain any of various additives such as viscosity adjusting agent, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, and ultraviolet ray absorbing agents, without departing from the objects of the present invention.

(3) Method for Producing Pressure-Sensitive Adhesive Layer-Attached Optical Film

As a non-limiting example, the pressure-sensitive adhesive layer-attached optical film of the invention can be produced by a method that includes applying the anchor layer formation composition to an optical film, drying the composition to form an anchor layer, and applying the pressure-sensitive adhesive composition to the formed anchor layer to form a pressure-sensitive adhesive layer on the anchor layer.

The pressure-sensitive adhesive composition, the anchor layer formation composition, and the optical film may be those described above.

The method may also include an adhesion facilitating treatment step, in which the surface of the optical film, on which the anchor layer is to be formed, is subjected to an adhesion facilitating treatment before the anchor layer is formed. In this case, the anchor layer formation composition is applied to the optical film surface having undergone the adhesion facilitating treatment.

The adhesion promoting treatment may be, for example, a corona treatment or a plasma treatment. When the anchor layer-receiving surface of the optical film is subjected to a corona treatment or a plasma treatment, the pressure-sensitive adhesive layer can have higher tackiness to the optical film.

The anchor layer formation composition is preferably applied to the optical film so as to form a coating with a thickness of 20 μm or less before drying. If the coating before drying is too thick (the amount of the applied anchor layer formation composition is too large), the solvent may easily affect the coating and promote cracking. If the coating is too thin, the adhesion between the optical film and the pressure-sensitive adhesive layer may be insufficient, which may reduce durability. Thus, the thickness of the coating is preferably from 2 to 17 μm, more preferably from 4 to 13 μm to prevent cracking and improve durability. The coating thickness before drying can be calculated from the thickness of the anchor layer after drying and the content of the binder resin in the anchor layer formation composition.

The anchor layer formation composition may be applied by any application method such as coating, dipping, or spraying.

After applied, the anchor layer formation composition is subjected to drying, in which the drying temperature and the drying time are typically, but not limited to, about 20 to about 70° C. and about 5 to about 200 seconds, respectively.

After the drying, the anchor layer preferably has a thickness (dry thickness) of 3 to 300 nm, more preferably 5 to 180 nm, even more preferably 11 to 90 nm. An anchor layer with a thickness of less than 3 nm may be not enough to ensure the anchoring between the optical film and the pressure-sensitive adhesive layer. On the other hand, an anchor layer with a thickness of more than 300 nm may be too thick to have sufficient, strength, so that cohesive failure may easily occur in such an anchor layer and sufficient, anchoring may fail to be achieved in some cases.

The pressure-sensitive adhesive layer-attached optical film of the invention can be produced by forming the anchor layer on the optical film and then forming the pressure-sensitive adhesive layer on the anchor layer of the resulting anchor layer-carrying optical film.

Examples of the method for depositing the pressure-sensitive adhesive layer include, but are not limited to, a method including applying the pressure-sensitive adhesive composition to the anchor layer of the anchor layer-carrying optical film and drying the composition, to form a pressure-sensitive adhesive layer; and a method including forming a pressure-sensitive adhesive layer on a release film and transferring the pressure-sensitive adhesive layer onto the anchor layer.

Any of various methods may be used in the step of applying the pressure-sensitive adhesive composition. Examples of the application method include roll coating, kiss roll coating, gravure coating, reverse coating, roll brush coating, spray coating, dip roll coating, bar coating, knife coating, air knife coating, curtain coating, lip coating, die coating, and any other extrusion coating.

In the applying step, the amount of the application is so controlled that a pressure-sensitive adhesive layer can be formed with a desired thickness (post-drying thickness). The thickness (post-drying thickness) of the pressure-sensitive adhesive layer is generally from about 1 to about 100 μm, preferably from 5 to 50 μm, more preferably from 10 to 40 μm.

In the process of forming the pressure-sensitive adhesive layer, the applied pressure-sensitive adhesive composition is then subjected to drying. The drying temperature is generally from about 80 to about 170° C., preferably from 80 to 160° C. The drying time is generally from about 0.5 to about 30 minutes, preferably from 1 to 10 minutes.

The material used to form, the release film may be any appropriate thin material, examples of which include a plastic film, a porous material such as a paper sheet, a cloth, or a nonwoven fabric, a net, a foam sheet, a metal foil, and any laminate thereof. A plastic film is advantageously used because it has high surface smoothness.

The plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The thickness of the release film is generally from about 5 to about 2 00 μm, preferably from about 5 to about 100 μm. If necessary, the release film may be subjected to a release treatment and an antifouling treatment, with a silicone, fluoride, long-chain alkyl, or fatty acid amide release agent, silica powder, or the like, or subjected to an antistatic treatment of coating type, kneading and mixing type, vapor-deposition type, or the like. Particularly when the surface of the release film is appropriately subjected to a release treatment such as a silicone treatment, a long-chain alkyl treatment, or a fluorine treatment, the releasability from the pressure-sensitive adhesive layer can be further increased.

When the pressure-sensitive adhesive layer is exposed, the pressure-sensitive adhesive layer may be protected by a release film until it is actually used. The release film may be used by itself as a separator for the pressure-sensitive adhesive layer-attached optical film, so that the process can be simplified.

The pressure-sensitive adhesive layer-attached optical film of the invention preferably has an anchoring strength of 20 N/25 mm or more, more preferably 25 N/25 mm or more. The anchor layer formation, composition according to the invention, which includes, as mentioned above, an oxazoline group-containing polymer and an ionic compound including a cation, component, and a sulfonyl group-containing anion component, can form an anchor layer capable of having a high anchoring strength when it is interposed between an optical film and a pressure-sensitive adhesive layer. The anchoring strength can be measured by the method described in the EXAMPLES section.

4. Image Display Device

The pressure-sensitive adhesive layer-attached optical film of the present invention is preferably usable for formation of various image display devices such as a liquid crystal display device, and others. The liquid crystal display device may be formed according to the prior art. Specifically, a liquid crystal display device is generally formed, for example, by fabricating appropriately a liquid crystal cell, a pressure-sensitive adhesive layer-attached optical film, an optional lighting system and other constituent members as needed, and integrating a driving circuit thereinto. In the present invention, a liquid crystal display device is formed according to such a conventional method, and is not particularly limited except that the pressure-sensitive adhesive layer-attached optical film according to the present invention is used. For the liquid crystal cell, a cell in any mode, such as a TN, STN, π, VA, or IPS mode may be used.

The present invention is used to make it possible to form an appropriate liquid crystal display device, such as a liquid crystal display device in which the pressure-sensitive adhesive layer-attached optical film is arranged on one or both surfaces of a display panel such as a liquid crystal cell, or a display device in which a backlight or a reflector is used for a lighting system. In this case, the pressure-sensitive adhesive layer-attached optical film according to the present invention may be provided at one or both sides of the display panel such as the liquid crystal cell. When the pressure-sensitive adhesive layer-attached optical films are provided at both sides, the optical members may be the same or different. Further, when the liquid crystal display device is formed, any appropriate members such as a diffusion plate, an antiglare layer, a reflection reduction film, a protective plate, a prism array, a lens array sheet, a light diffusion plate, a backlight and the like may be arranged as one or more layers at any appropriate positions.

The following will describe an organic electroluminescence device (organic EL display device: OLED). Generally, in an organic EL display device, a transparent electrode, an organic luminous layer and a metal electrode are laminated in order onto a transparent substrate to form a luminous body (organic electroluminescence body). Here, the organic luminous layer is a laminate composed of various organic thin, films. As the structure of this layer, structures having a combination that may be of various types are known, for example, a laminate composed of a hole injection layer made of, for example, a triphenylamine derivative, and a luminous layer made of a fluorescent, organic solid such, as anthracene, a laminate composed of such a luminous layer and an electron injection layer made of, for example, a perylene derivative, or a laminate composed of a hole injection layer, a luminous layer and an electron injection layer as described herein.

In an organic EL display device, by applying a voltage to its transparent, electrode and its metal electrode, holes and electrons are injected into the organic luminous layer, and these holes and electrons are recombined to generate an energy. In turn, the energy excites the fluorescent, substance. When the excited fluorescent substance is returned to a ground state thereof, light is radiated. By this principle, light is emitted. The mechanism of the recombination in the middle of this process is equivalent to that of ordinary diodes. As can be expected also from this matter, the electric current and the luminescence intensity show an intense non-linearity, with rectification, relative to an applied voltage.

In an organic EL display device, at least one of its electrodes needs to be transparent to take out luminescence from its organic luminous layer. Usually, its transparent electrode made of a transparent electroconductor such as indium tin oxide (ITO) is used as a positive electrode. Meanwhile, in order to make the injection of electrons easy to raise the luminescence efficiency, it is important to use a substance with small working function for a negative electrode. Usually, an electrode made of a metal, such as Mg—Ag or Al—Li, is used.

In an organic EL display device having such a structure, its organic luminous layer is formed of a very thin film having a thickness of about 10 nm. Thus, like the transparent electrode, the organic luminous layer transmits light substantially completely. As a result, when no light is emitted, light enters from a surface of the transparent substrate, penetrates the transparent electrode and the organic luminous layer and then reflects on the metal electrode and again goes out to the surface of the transparent substrate. Accordingly, when the organic EL display device is viewed from the outside, the display surface of the device looks like a mirror plane.

In an organic EL display device containing an organic electroluminescent body which is formed by providing a transparent electrode on the front surface side of the organic luminous layer which emits light by applying a voltage thereto, and further providing a metal electrode on the rear surface side of the organic luminous layer, a polarizing plate may be located on the front surface side of the transparent electrode and further a retardation plate may be interposed between the transparent electrode and the polarizing plate.

Since the retardation plate and the polarizing plate have an action of polarizing light radiated thereinto from the outside and then reflected on the metal electrode, there is an effect that the mirror plane of the metal electrode cannot be viewed from the outside by the polarizing action. In particular, when the retardation plate is composed of a 1/4 wavelength plate and the angle between the respective polarizing directions of the polarizing plate and the retardation plate is adjusted to π/4, the mirror plane of the metal electrode can be completely shielded.

In short, about external light radiated into this organic EL display device, only its linearly polarized light component is transmitted by effect of the polarizing plate. This linearly polarized light ray is generally turned to an elliptically polarized light ray by effect of the retardation plate. However, particularly, when the retardation plate is a 1/4 wavelength plate and further the angle between the respective polarizing directions of the polarizing plate and the retardation plate is π/4, the light ray is turned to a circularly polarized light ray.

This circularly polarized light ray is transmitted through the transparent substrate, the transparent electrode, and the organic thin film, reflected on the metal electrode, and again transmitted through the organic thin film, the transparent electrode and the transparent substrate to be again turned to a linearly polarized light ray through the retardation plate. This linearly polarized light ray is perpendicular to the polarizing direction of the polarizing plate so as not to be transmissible through the polarizing plate. As a result, the mirror plane of the metal electrode can be completely shielded.

### EXAMPLES

Hereinafter, the present invention will be specifically described by way of examples. However, the present invention is not limited by these examples. In each of the examples, the word “part(s)” and the symbol “%” denote “part(s) by weight” and “% by weight”, respectively.

### Example 1

(Preparation of Pressure-Sensitive Adhesive Composition)

A reaction vessel quipped with a condenser tube, a nitrogen inlet tube, a thermometer, and a stirrer was charged with 100 parts by weight of butyl acrylate, 5 parts by weight of acrylic acid, 0.075 parts by weight of hydroxyethyl acrylate, and benzoyl peroxide (BOP) as an initiator in an amount of 1 part by weight (on a solid basis) based on 100 parts by weight (on a solid basis) of the monomers, together with ethyl acetate. The mixture was allowed to react at 60° C. for 7 hours under a nitrogen gas stream. Subsequently, ethyl acetate was added to the reaction liquid to form a solution (solid concentration 30% by weight) containing a (meth)acrylic ester copolymer with a weight average molecular weight of 1,600,000.

Based on 100 parts by weight of the solid content of the resulting acrylic ester copolymer-containing solution (solid concentration 30% by weight), 0.6 parts by weight of trimethylolpropane/tolylene diisocyanate trimer adduct (CORONATE L (trade name) manufactured by Nippon Polyurethane Industry Co., Ltd.) as a crosslinking agent and 0.075 parts by weight of γ-glycidoxypropyltrimethoxysilane (KBM-403 (trade name) manufactured by Shin-Etsu Chemical Co., Ltd. ) as a silane coupling agent were added to the acrylic ester copolymer-containing solution to form a pressure-sensitive adhesive composition (1).

(Preparation of Anchor Layer Formation Composition)

An anchor layer formation composition (1) was prepared by mixing 0.25% by weight of an oxazoline group-containing polymer (EPOCROS WS-700 manufactured by NIPPON SHOKUBAI CO., LTD.) and 0.05% by weight of lithium bis(nonafluorobutanesulfonyl)imide (EF-N445 (trade name) manufactured by Mitsubishi Materials Electronic Chemicals Co., Ltd.) into a water solvent.

(Preparation of Pressure-Sensitive Adhesive-Type Optical Film)

Using a wire bar #5, the anchor layer formation composition (1) was applied to the protective-layer-free surface (polarizer side) of a one-side-protected polarizing film so that an about. 10-μm-thick coating could be formed. The coating was then dried, at 30° C. for 3 minutes, so that an anchor layer-attached polarizing film having an about 50-nm-thick anchor layer was obtained. The pressure-sensitive adhesive composition (1) was applied to a release agent-treated polyester film (PET film) and then heat-treated at 150° C. for 2 minutes to form a 20-μm-thick pressure-sensitive adhesive layer. The coated polyester film was attached to the anchor layer surface of the anchor layer-attached polarizing film to form a pressure-sensitive adhesive-type optical film.

### Examples 2 to 7

Pressure-sensitive adhesive-type optical films were prepared as in Example 1, except that the composition of the anchor layer formation composition (1) used in Example 1 was changed to the composition shown in Table 1.

### Example 8

A pressure-sensitive adhesive-type optical film was prepared as in Example 1, except that the one-side-protected polarizing film was replaced with a double-side-protected polarizing film and the anchor layer was formed on one of the protective films of the double-side-protected polarizing film.

### Example 9

(Preparation of Pressure-Sensitive Adhesive Composition)

A reaction vessel quipped with a condenser tube, a nitrogen inlet tube, a thermometer, and a stirrer was charged with 98.8 parts by weight of butyl acrylate, 0.2 parts by weight of acrylic acid, 1.0 part by weight of 4-hydroxybutyl acrylate, and azobisisobutyronitrile (AIBN) as an initiator in an amount of 1 part by weight based on 100 parts by weight (on a solid basis) of the monomers, together with ethyl acetate. The mixture was allowed to react at 60° C. for 7 hours under a nitrogen gas stream. Subsequently, ethyl acetate was added to the reaction liquid to form a solution (solid concentration 30% by weight) containing a (meth)acrylic ester copolymer with a weight average molecular weight of 1,500,000.

Based on 100 parts by weight of the solid content of the resulting acrylic ester copolymer-containing solution (solid concentration 30% by weight), 0.15 parts by weight of a trimethylolpropane adduct of xylylene diisocyanate (D110N (trade name) manufactured by Mitsui Chemicals, Inc.) as a crosslinking agent and 0.2 parts by weight, of an acetoacetyl group-containing silane coupling agent (A-100 (trade name) manufactured by Soken Chemical & Engineering Co., Ltd.) were added to the acrylic ester copolymer-containing solution to form a pressure-sensitive adhesive composition (2).

A pressure-sensitive adhesive-type optical film was prepared using the same process as in Example 2, except that the pressure-sensitive adhesive composition (1) was replaced with the pressure-sensitive adhesive composition (2).

### Example 10

(Preparation of Pressure-Sensitive Adhesive Composition)

To a vessel were added 92 parts by weight of butyl acrylate, 1 part by weight of acrylic acid, 5 parts by weight of cyclohexyl methacrylate, 2 parts by weight of mono[poly(propylene oxide)methacrylate]phosphate ester (about 5.0 in average degree of polymerization of propylene oxide), and 0.03 parts by weight of 3-methacryloyloxypropyl-trimethoxysilane (KBM-503 manufactured by Shin-Etsu Chemical Co., Ltd.) as reactive components and mixed to form a monomer mixture.

Subsequently, 46.6 g of a reactive emulsifier AQUALON HS-10 (manufactured by DKS Co. Ltd.) and 109 g of ion-exchanged water were added to 388 g of the prepared monomer mixture and then emulsified at 5,000 l/min for 5 minutes with a homogenizer (manufactured by PRIMIX Corporation) to form a monomer pre-emulsion.

A reaction vessel equipped with a condenser tube, a nitrogen inlet tube, a thermometer, and a stirrer was charged with 54 g part of the prepared monomer pre-emulsion and 456 g of ion-exchanged water. Subsequently, after the air in the reaction vessel was replaced with nitrogen, 0.3 g of ammonium persulfate was added to the mixture. The resulting mixture was subjected to polymerization at 65° C. for 2 hours. Subsequently, 489.6 g remainder of the monomer pre-emulsion was added dropwise to the reaction vessel over 3 hours and then subjected to polymerization for 3 hours to form an emulsion solution of an aqueous dispersion-type pressure-sensitive adhesive composition with a solid content of 40%. Subsequently, after the emulsion solution was cooled to room temperature, 10% ammonia water was added thereto to adjust the pH to 8, so that an aqueous dispersion-type acrylic pressure-sensitive adhesive (3 ) was obtained.

A pressure-sensitive adhesive-type optical film was prepared using the same process as in Example 1, except that the pressure-sensitive adhesive composition (1) was replaced with the aqueous dispersion-type acrylic pressure-sensitive adhesive (3).

### Example 11

(Preparation of Pressure-Sensitive Adhesive Composition)

To a vessel were added 88 parts of butyl acrylate, 5 parts of acrylic acid, 5 parts of cyclohexyl methacrylate, 2 parts of mono[poly(propylene oxide)methacrylate]phosphate ester (about 5.0 in average degree of polymerization of propylene oxide), and 0.03 parts of 3-methacryloyloxypropyl-trimethoxysilane (KBM-503 manufactured by Shin-Etsu Chemical Co., Ltd.) as reactive components and mixed to form a monomer mixture.

Subsequently, 46.6 g of a reactive emulsifier AQUALON HS-10 (manufactured by DKS Co. Ltd.) and 109 g of ion-exchanged water were added to 388 g of the prepared monomer mixture and then emulsified at 5,000 l/min for 5 minutes with a homogenizer (manufactured by PRIMIX Corporation) to form a monomer pre-emulsion.

A reaction vessel equipped with a condenser tube, a nitrogen inlet tube, a thermometer, and a stirrer was charged with 54 g part of the prepared monomer pre-emulsion and 456 g of ion-exchanged water. Subsequently, after the air in the reaction vessel was replaced with nitrogen, 0.3 g of ammonium persulfate was added to the mixture. The resulting mixture was subjected to polymerization at 65° C. for 2 hours. Subsequently, 489.6 g remainder of the monomer pre-emulsion was added dropwise to the reaction vessel over 3 hours and then subjected to polymerization for 3 hours to form an emulsion solution of an aqueous dispersion-type pressure-sensitive adhesive composition with a solid content of 40%. Subsequently, after the emulsion solution was cooled to room temperature, 10% ammonia water was added thereto to adjust the pH to 8, so that an aqueous dispersion-type acrylic pressure-sensitive adhesive (4) was obtained.

A pressure-sensitive adhesive-type optical film was prepared using the same process as in Example 1, except that the pressure-sensitive adhesive composition (1) was replaced with the aqueous dispersion-type acrylic pressure-sensitive adhesive (4).

### Examples 12 to 17

Pressure-sensitive adhesive-type optical films were prepared using the same process as in Example 11, except that the composition of the anchor layer formation composition and the polarizing film were changed as shown in Table 1.

### Example 18

(Preparation of Pressure-Sensitive Adhesive Composition)

To a vessel were added 91 parts by weight of 2-ethylhexyl acrylate, 4 parts by weight of acrylic acid, 5 parts by weight of cyclohexyl methacrylate, and 0.04 parts by weight of 3-methacryloyloxypropyl-triethoxysilane (KBM-503 manufactured by Shin-Etsu Chemical Co., Ltd.) as reactive components and mixed to form a monomer mixture.

Subsequently, 24.8 g of a reactive emulsifier ELEMINOL JS-20 (trade name, manufactured by Sanyo Chemical Industries, Ltd.) and 431.2 g of ion-exchanged water were added to 66.4 g of the prepared monomer mixture and then emulsified at 3,000 l/min for 5 minutes with a homogenizer (manufactured by PRIMIX Corporation) to form a monomer pre-emulsion (5-1).

To a vessel were added 52.9 parts by weight of butyl acrylate, 37 parts by weight of methyl methacrylate, 1.1 parts by weight of a phosphate group-containing monomer (Simpomer PAM200 manufactured by Rhodia Nicca, Ltd.), 4 parts by weight of acrylic acid, 5 parts by weight of cyclohexyl methacrylate, and 0.04 parts by weight of 3-methacryloyloxypropyl-triethoxysilane (KBM-503 manufactured by Shin-Etsu Chemical Co., Ltd.) as raw materials and mixed to form a monomer mixture.

Subsequently, 13.9 g of a reactive emulsifier ELEMINOL JS-20 (manufactured by Sanyo Chemical Industries, Ltd.) and 826 g of water were added to 995.5 g of the prepared monomer mixture and then stirred at 3,000 rpm for 5 minutes with a homomixer (manufactured by PRIMIX Corporation) to form a monomer emulsion (5-2).

Subsequently, a reaction vessel equipped with a condenser tube, a nitrogen inlet tube, a thermometer, a dropping funnel, and a stirring blade was charged with 512 g part of the prepared monomer emulsion (5-1). Subsequently, after the air in the reaction vessel was sufficiently replaced with nitrogen, the inner bath temperature was controlled to 65° C., and 1.62 g of an aqueous solution of 2% by weight of ammonium peroxosulfate sodium (APS) was added to the reaction vessel. The mixture was subjected to polymerization for 2 hours. Subsequently, after 6.49 g of an aqueous solution of 5% by weight of ammonium peroxosulfate sodium (APS) was added to the reaction vessel, 1,080 g part of the monomer emulsion (5-2) was added dropwise to the reaction vessel over 3 hours while the inner bath temperature was kept at 65° C. The mixture was then further subjected to polymerization for 3 hours.

An aqueous dispersion-type acrylic pressure-sensitive adhesive (5) was prepared by adding 3 parts by weight of 10% ammonia water to 100 parts by weight of the resulting aqueous dispersion (emulsion).

A pressure-sensitive adhesive-type optical film was prepared using the same process as in Example 1, except that the pressure-sensitive adhesive composition (1) was replaced with the aqueous dispersion-type acrylic pressure-sensitive adhesive (5).

### Examples 19 to 27

Pressure-sensitive adhesive-type optical films were prepared using the same process as in Example 18, except that the composition of the anchor layer formation composition and the polarizing film were changed as shown in Table 1.

### Comparative Examples 1 to 6

Pressure-sensitive adhesive-type optical films were prepared using the same process as in Example 1, except that the composition of the anchor layer formation composition and the polarizing film were changed as shown in Table 2.

### Comparative Example 7

A pressure-sensitive adhesive-type optical film was prepared using the same process as in Example 9, except that the composition of the anchor layer formation composition was changed as shown in Table 2.

### Comparative Example 8

A pressure-sensitive adhesive-type optical film was prepared using the same process as in Example 10, except that the composition of the anchor layer formation composition was changed as shown in Table 2.

### Comparative Examples 9 to 15

Pressure-sensitive adhesive-type optical films were prepared using the same process as in Example 11, except that the composition of the anchor layer formation composition and the polarizing film were changed as shown in Table 2.

### Comparative Examples 16 to 21

Pressure-sensitive adhesive-type optical films were prepared using the same process as in Example 18, except that the composition of the anchor layer formation composition and the polarizing film were changed as shown in Table 2.

The pressure-sensitive adhesive layer-attached polarizing films obtained in the examples and the comparative examples were evaluated as described below. Tables 1 and 2 show the evaluation results.

<Anchoring Strength>

The PET film was peeled off from the pressure-sensitive adhesive layer-attached optical film obtained in each of the examples and the comparative examples. An ITO film (125 Tetolight OES manufactured by OIKE & Co., Ltd. ) was then bonded to the exposed surface of the pressure-sensitive adhesive layer-attached optical film. A 25-mm-wide piece was cut from the resulting laminate. Using a tensile tester, the pressure-sensitive adhesive layer-attached polarizing film was peeled off from the laminate at an angle of 180° and a rate of 300 mm/minute. The resulting peel strength (N/25 mm) was determined as the anchoring strength.

TABLE 1

| | | | | Anchor layer-attached polarizing film | | | | |
|---|---|---|---|---|---|---|---|---|
| | | | | Anchor layer | | | | |
| | Pressure-sensitive adhesive layer | | | Oxazoline | | | | |
| | | | Acrylic | group- | | | | Anchoring |
| | Solvent-based/ | | acid | containing | Conductive | Ionic | | strength |
| | Em-based | Form | (wt parts) | polymer | agent | compound | Polarizing film | N/25 mm) |
| Example 1 | Solvent-based | Uniform | 5 | WS700 | — | EF-N445 | One-side-protected | 35 |
| | | | | 0.25 wt % | | 0.05 wt % | | |
| Example 2 | Solvent-based | Uniform | 5 | WS700 | — | EF-N115 | One-side-protected | 34 |
| | | | | 0.25 wt % | | 0.05 wt % | | |
| Example 3 | Solvent-based | Uniform | 5 | WS700 | — | Li (SO₂F) ₂N | One-side-protected | 41 |
| | | | | 0.25 wt % | | 0.05 Wt % | | |
| Example 4 | Solvent-based | Uniform | 5 | WS700 | — | LiCF₃SO₃ | One-side-protected | 40 |
| | | | | 0.25 wt % | | 0.05 Wt % | | |
| Example 5 | Solvent-based | Uniform | 5 | WS700 | — | EF-N115 | One-side-protected | 30 |
| | | | | 0.25 wt % | | 1.0 wt % | | |
| Example 6 | Solvent-based | Uniform | 5 | WS700 | P-580W | EF-N445 | One-side-protected | 36 |
| | | | | 0.225 wt % | 0.275 wt % | 0.05 wt % | | |
| Example 7 | Solvent-based | Uniform | 5 | WS700 | P-580W | EF-N445 | One-side-protected | 32 |
| | | | | 0.50 wt % | 0.50 wt % | 2.0 wt % | | |
| Example 8 | Solvent-based | Uniform | 5 | WS700 | — | EF-N445 | Double-side-protected | 31 |
| | | | | 0.25 wt % | | 0.05 wt % | | |
| Example 9 | Solvent-based | Uniform | 0.2 | WS700 | — | EF-N115 | One-side-protected | 14 |
| | | | | 0.25 wt % | | 0.05 wt % | | |
| Example 10 | Em-based | Uniform | 1 | WS700 | — | EF-N445 | One-side-protected | 28 |
| | | | | 0.25 wt % | | 0.05 wt % | | |
| Example 11 | Em-based | Uniform | 5 | WS700 | — | EF-N445 | One-side-protected | 34 |
| | | | | 0.25 wt % | | 0.05 wt % | | |
| Example 12 | Em-based | Uniform | 5 | WS700 | — | EF-N115 | One-side-protected | 36 |
| | | | | 0.25 wt % | | 0.05 wt % | | |
| Example 13 | Em-based | Uniform | 5 | WS700 | | Li (SO₂F) ₂N | One-side-protected | 38 |
| | | | | 0.25 wt % | | 0.05 Wt % | | |
| Example 14 | Em-based | Uniform | 5 | WS700 | | LiCF₃SO₃ | One-side-protected | 37 |
| | | | | 0.25 wt % | | 0.05 Wt % | | |
| Example 15 | Em-based | Uniform | 5 | WS700 | P-580W | EF-N445 | One-side-protected | 35 |
| | | | | 0.225 wt % | 0.275 wt % | 0.05 wt % | | |
| Example 16 | Em-based | Uniform | 5 | WS700 | — | EF-N445 | Double-side-protected | 27 |
| | | | | 0.25 wt % | | 0.05 wt % | | |
| Example 17 | Em-based | Uniform | 5 | WS700 | P-580W | EF-N445 | Double-side-protected | 26 |
| | | | | 0.225 wt % | 0.275 wt % | 0.05 wt % | | |
| Example 18 | Em-based | Core-shell | 4 | WS700 | — | EF-N445 | One-side-protected | 35 |
| | | | | 0.25 wt % | | 0.05 wt % | | |
| Example 19 | Em-based | Core-shell | 4 | WS700 | | EF-N115 | One-side-protected | 33 |
| | | | | 0.25 wt % | | 0.05 wt % | | |
| Example 20 | Em-based | Core-shell | 4 | WS700 | | Li (SO₂F) ₂N | One-side-protected | 41 |
| | | | | 0.25 wt % | | 0.05 Wt % | | |
| Example 21 | Em-based | Core-shell | 4 | WS700 | | LiCF₃SO₃ | One-side-protected | 40 |
| | | | | 0.25 wt % | | 0.05 Wt % | | |
| Example 22 | Em-based | Core-shell | 4 | WS700 | P-580W | EF-N445 | One-side-protected | 43 |
| | | | | 0.225 wt % | 0.275 wt % | 0.05 wt % | | |
| Example 23 | Em-based | Core-shell | 4 | WS700 | P-580W | EF-N445 | One-side-protected | 33 |
| | | | | 0.225 wt % | 0.275 wt % | 1.0 wt % | | |
| Example 24 | Em-based | Core-shell | 4 | WS700 | P-580W | EF-N445 | One-side-protected | 35 |
| | | | | 0.15 wt % | 0.20 wt % | 0.10 wt % | | |
| Example 25 | Em-based | Core-shell | 4 | WS700 | P-580W | EF-N445 | One-side-protected | 39 |
| | | | | 0.15 wt % | 0.20 wt % | 0.10 wt % | | |
| Example 26 | Em-based | Core-shell | 4 | WS700 | P-580W | EF-N445 | One-side-protected | 35 |
| | | | | 0.15 wt % | 0.20 wt % | 0.10 wt % | | |
| Example 27 | Em-based | Core-shell | 4 | WS700 | — | EF-N445 | Double-side-protected | 52 |
| | | | | 0.25 wt % | | 0.05 wt % | | |

TABLE 2

| | | | | Anchor layer-attached polarizing film | | | | | |
|---|---|---|---|---|---|---|---|---|---|
| | | | | Anchor layer | | | | | |
| | Pressure-sensitive adhesive layer | | | Oxazoline | | | | | |
| | | | Acrylic | group- | | | | | Anchoring |
| | Solvent-based/ | | acid | containing | | Conductive | Ionic | | strength |
| | Em-based | Form | (wt parts) | polymer | Binder | agent | compound | Polarizing film | N/25 mm) |
| Comparative | Solvent-based | Uniform | 5 | WS700 | | — | — | One-side-protected | 18 |
| Example 1 | | | | 0.25 wt % | | | | | |
| Comparative | Solvent-based | Uniform | 5 | — | | P-580W | — | One-side-protected | 9 |
| Example 2 | | | | | | 0.275 wt % | | | |
| Comparative | Solvent-based | Uniform | 5 | — | | P-580W | EF-N445 | One-side-protected | 9 |
| Example 3 | | | | | | 0.275 wt % | 0.05 wt % | | |
| Comparative | Solvent-based | Uniform | 5 | WS700 | | P-580W | — | One-side-protected | 19 |
| Example 4 | | | | 0.225 wt % | | 0.275 wt % | | | |
| Comparative | Solvent-based | Uniform | 5 | WS700 | | — | TC-310 | One-side-protected | 19 |
| Example 5 | | | | 0.25 wt % | | | 0.05 wt % | | |
| Comparative | Solvent-based | Uniform | 5 | WS700 | | — | — | Double-side-protected | 15 |
| Example 6 | | | | 0.25 wt % | | | | | |
| Comparative | Solvent-based | Uniform | 0.2 | WS700 | | — | — | One-side-protected | 6 |
| Example 7 | | | | 0.25 wt % | | | | | |
| Comparative | Em-based | Uniform | 1 | WS700 | | — | — | One-side-protected | 8 |
| Example 8 | | | | 0.25 wt % | | | | | |
| Comparative | Em-based | Uniform | 5 | WS700 | | — | — | One-side-protected | 20 |
| Example 9 | | | | 0.25 wt % | | | | | |
| Comparative | Em-based | Uniform | 5 | — | B-510 | — | — | One-side-protected | 3 |
| Example 10 | | | | | 0.10 Wt % | | | | |
| Comparative | Em-based | Uniform | 5 | — | B-510 | — | EF-N445 | One-side-protected | 4 |
| Example 11 | | | | | 0.10 Wt % | | 0.05 wt % | | |
| Comparative | Em-based | Uniform | 5 | — | | P-580W | — | One-side-protected | 5 |
| Example 12 | | | | | | 0.275 wt % | | | |
| Comparative | Em-based | Uniform | 5 | — | | P-580W | EF-N445 | One-side-protected | 5 |
| Example 13 | | | | | | 0.275 wt % | 0.05 wt % | | |
| Comparative | Em-based | Uniform | 5 | WS700 | | P-580W | — | One-side-protected | 23 |
| Example 14 | | | | 0.225 wt % | | 0.275 wt % | | | |
| Comparative | Em-based | Uniform | 5 | WS700 | | — | — | Double-side-protected | 12 |
| Example 15 | | | | 0.25 wt % | | | | | |
| Comparative | Em-based | Core-shell | 4 | WS700 | | — | — | One-side-protected | 4 |
| Example 16 | | | | 0.25 wt % | | | | | |
| Comparative | Em-based | Core-shell | 4 | — | | P-580W | — | One-side-protected | 2 |
| Example 17 | | | | | | 0.275 wt % | | | |
| Comparative | Em-based | Core-shell | 4 | — | | P-580W | EF-N445 | One-side-protected | 2 |
| Example 18 | | | | | | 0.275 wt % | 0.05 wt % | | |
| Comparative | Em-based | Core-shell | 4 | WS700 | | P-580W | — | One-side-protected | 6 |
| Example 19 | | | | 0.225 wt % | | 0.275 wt % | | | |
| Comparative | Em-based | Core-shell | 4 | WS700 | | — | TC-310 | One-side-protected | 2 |
| Example 20 | | | | 0.25 wt % | | | 0.05 wt % | | |
| Comparative | Em-based | Core-shell | 4 | WS700 | | — | — | Double-side-protected | 14 |
| Example 21 | | | | 0.25 wt % | | | | | |

Tables 1 and 2 use the following abbreviations.

P-580W: Denatron P-580W, a solution containing 10 to 50% by weight of a thiophene polymer, manufactured by Nagase ChemteX Corporation

WS-700: EPOCROS WS-700, a solution containing an oxazoline group-containing acrylic polymer, manufactured by NIPPON SHOKUBAI CO., LTD.

WS-500: EPOCROS WS-500, a solution containing an oxazoline group-containing acrylic polymer, manufactured by NIPPON SHOKUBAI CO., LTD.

WS-300: EPOCROS WS-300, a solution containing an oxazoline group-containing acrylic polymer, manufactured by NIPPON SHOKUBAI CO., LTD.

TC-310: ORGATIX TC-310, titanium, lactate, manufactured by Matsumoto Fine Chemical Co., Ltd.

B-510: Denatron B-510, a solution containing a urethane polymer, manufactured by Nagase ChemteX Corporation

EF-N445: lithium bis(nonafluorobutanesulfonyl)imide, manufactured by manufactured by Mitsubishi Materials Electronic Chemicals Co., Ltd.

EF-N115: lithium bis(trifluoromethanesulfonyl)imide, manufactured by Mitsubishi Materials Electronic Chemicals Co., Ltd.

Li(SO₂F)₂N: Li(SO₂F)₂N manufactured by NIPPON SHOKUBAI CO., LTD.

LiCF₃SO₃: LiCF₃SO₃ manufactured by MORITA CHEMICAL INDUSTRIES CO., LTD.

1. An anchor layer formation composition, comprising:
an oxazoline group-containing polymer; and
an ionic compound comprising a cation component and a sulfonyl group-containing anion component.

2. The anchor layer formation composition according to claim 1, wherein the anion component is at least one anion component selected from the group consisting of an anion component represented by formula (1): (CₙF₂ₙ₊₁SO₂)N⁻(SO₂CₘF₂ₘ₊₁), wherein n and m are each independently an integer of 1 to 10, (SO₂F)₂N⁻, and CF₃SO₃⁻.

3. The anchor layer formation composition according to claim 1, wherein the cation component is a lithium cation.

4. The anchor layer formation composition according to claim 1, wherein the ionic compound is lithium bis(nonafluorobutanesulfonyl)imide and/or lithium bis(trifluoromethanesulfonyl)imide.

5. An anchor layer comprising a product made from the anchor layer formation composition according to claim 1.

6. A pressure-sensitive adhesive layer-attached optical film, comprising:
an optical film;
the anchor layer according to claim 5; and
a pressure-sensitive adhesive layer made from a pressure-sensitive adhesive composition,
wherein the anchor layer is interposed between the optical film and the pressure-sensitive adhesive layer.

7. The pressure-sensitive adhesive layer-attached optical film according to claim 6, wherein the pressure-sensitive adhesive composition comprises a (meth)acryl-based polymer obtained by polymerizing a monomer composition comprising a (meth)acrylic ester and a carboxyl group-containing monomer.

8. The pressure-sensitive adhesive layer-attached optical film according to claim 7, wherein the carboxyl group-containing monomer makes up 0.05 to 20% by weight of all monomers used to form the (meth)acryl-based polymer.

9. An image display device comprising the pressure-sensitive adhesive layer-attached optical film according to claim 6.
